(19) United States
(12) Patent Application Publication
(10) Pub. No.: US 2014/0053050 A1
(43) Pub. Date: Feb. 20, 2014

(54) DOCUMENT FILE DISPLAY DEVICE AND METHOD

(71) Applicant: FUJI FILM Corporation, Tokyo (JP)

(72) Inventor: Hironori Yano, Tokyo (JP)

(73) Assignee: FUJI FILM Corporation, Tokyo (JP)

(21) Appl. No.: 14/062,663

(22) Filed: Oct. 24, 2013

Related U.S. Application Data
(63) Continuation of application No. PCT/JP2012/059327, filed on Apr. 5, 2012.

(30) Foreign Application Priority Data
Apr. 27, 2011 (JP) 2011-099694

(51) Int. Cl. G06F 17/21

(52) U.S. Cl. CPC G06F 17/212
USPC 715/202

(57) ABSTRACT

A document file display device comprising: a display unit; an image converting unit; a layout information detecting unit; an element image extracting unit; a line information generating unit; a scroll direction determining unit; a paragraph information generating unit that generates paragraph information by arranging a plurality of pieces of said line information along the scroll direction determined by the scroll direction determining unit; a display control unit that that makes a display of the paragraph information generated by the paragraph information generating unit in a display range of the display unit; and a scroll instructing unit that makes an instruction for scroll display of the paragraph information along the scroll direction, wherein the display control unit makes a scroll display of the paragraph information in the display range of the display unit along the scroll direction instructed by the scroll instructing unit.

### CROSS-REFERENCE TO RELATED APPLICATIONS

This application is a continuation application and claims the priority benefit under 35 U.S.C. §120 of PCT Application No. PCT/JP2012/059327 filed on Apr. 5, 2012 which application designates the U.S., and also claims the priority benefit under 35 U.S.C. §119 of Japanese Patent Application No. 2011-099694 filed on Apr. 27, 2011, which applications are all hereby incorporated by reference in their entireties.

### BACKGROUND OF THE INVENTION

1. Field of the Invention

The present invention relates to a device, method, and program for displaying various contents obtained by imaging documents such as newspapers, magazines, paper documents, textbooks, and reference books.

2. Description of the Related Art

With the information technological innovation in recent years, an information distribution mode has been established in which a book supposed to be printed on paper such as a magazine or comic book is digitalized and viewed via an image viewer on a smartphone or the like.

Non-Patent Literatures 1 and 2 disclose that a newspaper obtained by imaging is scrolled, enlarged, and reduced for users to read a newspaper article.

PTL 1 discloses a technology of viewing a file attached to an e-mail on a portable telephone.

PTL 2 discloses a technology of changing the layout of a document according to a portable terminal.

PTL 3 discloses a technology in which the layout of document data is converted to meta data and the layout is changed accordingly for printing.

### Patent Literatures are:

PTL 1: Japanese Patent Application Laid-Open No. 2007-199983;
PTL 2: Japanese Patent Application Laid-Open No. 11-122398; and
PTL 3: Japanese Patent Application Laid-Open No. 2008-176541.

### Non-Patent Literatures are:

Non-Patent Literature 1: “How to use Sankei NetView”, searched on Apr. 13, 2011, URL <http://www.sankei.co.jp/netview/howto_{—}1.html>; and
Non-Patent Literature 2: “Sankei Shimbun (iPhone version): Operation Method”, searched on Apr. 13, 2011, URL <http://www.sankei.co.jp/iphone>.

### SUMMARY OF THE INVENTION

With an advance in functionality of portable terminals in recent years, various data can be obtained via a network. For example, operations of obtaining an e-mail on a mail server and obtaining a file on a shared server can be performed. Data formats such as text data, compressed image data such as jpeg (Joint Photographic Experts Group), and HTML data can be viewed at almost every portable terminal. However, if data to be obtained is of a structured document file format (a document file other than a plain text file, such as Microsoft Word (registered trademark), Microsoft Excel (registered trademark), Microsoft Powerpoint (registered trademark), and Adobe PDF (registered trademark)), there are a few portable terminal with an application allowing the data to be viewed, under present circumstances. Under these circumstances, a technology for allowing a document file to be viewed even a viewer application is not incorporated in a portable terminal has been developed.

For example, a document file requested from a server side to be obtained is rendered (imaged), and the imaged data is transmitted to a portable terminal. The portable terminal reproduces the image, thereby allowing the document to be viewed with the same layout as that of the original document file. However, the generated image often has a layout based on the premise that the image is to be printed on paper.

In the case of a small display area as in a portable terminal, it is hard to say that the document can be comfortably viewed.

In PTL 1, not only a document file is rendered and imaged but also layout information and text information are extracted and transmitted together with the image to a portable phone. With this, text is displayed for an area where a character cannot be read in the image, thereby improving viewing usability. For this purpose, it is required to discriminate a character type in addition to a text area.

In PTL 2, the layout of a document image is changed according to the screen size. However, this cannot support a document obtained by imaging an office document or the like with a text document and an image mixed together with the same layout as it is.

The present invention was made in view of these problems, and has an object of improving viewability without discriminating a text character type when a document with an image and a text document are mixed together is displayed by an image viewer on a screen with a small display area.

The present invention provides a document file display device including a display unit that displays an image, an image converting unit that converts a structured document file to an image file, a layout information detecting unit that detects layout information including an area where each of elements configuring a document is present and an alignment direction of the elements from the converted image file by the image converting unit, an element image extracting unit that extracts, from the image file, an element image, which is a partial image corresponding to the area where each of the elements is present, based on the layout information detected by the layout information detecting unit, a line information generating unit that generates line information with a set of the element images fitting in the display unit, based on a size of each of the element images extracted by the element image extracting unit along the alignment direction of the elements, a scroll direction determining unit that determines a scroll direction of the line information generated by the line information generating unit according to the alignment direction of the elements, a paragraph information generating unit that generates paragraph information by arranging a plurality of pieces of said line information along the scroll direction determined by the scroll direction determining unit, a display control unit that that makes a display of the paragraph information generated by the paragraph information generating unit in a display range of the display unit, and a scroll instructing unit that makes an instruction for scroll display of the paragraph information along the scroll direction, the display control unit making a scroll display of the paragraph information in the display range of the display unit along the scroll direction instructed by the scroll instructing unit.

Preferably, the display control unit makes a reduced display of the image file as a whole and also causes information indicating an area where each document in the reduced and displayed image is present to be displayed, and the document file display device further includes an area selecting unit that selects an area where a desired document is present from the area where each document is present, the layout information detecting unit detects the layout information including the area where each of the elements is present and the alignment direction of the elements from the area where the document is present selected by the area selecting unit, and the display control unit makes a scroll display of paragraph information corresponding to the area where the document is present selected by the area selecting unit along the scroll direction instructed by the scroll instructing unit in a first area of the display unit in the display range of the display unit, and makes a reduced display of the whole image file in a second area different from the first area of the display unit.

Preferably, the scroll direction determining unit determines a direction orthogonal to the alignment direction of the elements as the scroll direction of the line information.

Preferably, the document file display device further includes the an enlargement/reduction ratio specifying unit that specifies an enlargement/reduction ratio for displaying the paragraph information, wherein the line information generating unit generates the line information with the set of the element images fitting in the display unit along the alignment direction of the elements, by following on a size obtained by enlarging or reducing each of the element images extracted by the element image extracting unit at the enlargement/reduction ratio specified by the enlargement/reduction ratio specifying unit

Preferably, the line information generating unit deletes, from the line information, an element image not satisfying a predetermined criterion.

Preferably, the paragraph information generating unit deletes, from the paragraph information, line information not satisfying a predetermined criterion.

Preferably, the line information generating unit includes element images adjacent to each other in the alignment direction of the elements on the image file in same line information

Preferably, the line information generating unit includes an element image subsequent to an element image adjacent to a previous element image previous to element images not satisfying a size at a predetermined ratio along the element direction in line information different from line information of the previous element image.

Preferably, when a size obtained by coupling different pieces of line information fits in the display unit along the alignment direction of the elements, the line information generating unit unifies the different line information into same line information.

Preferably, line information generating unit generates the line information so that an element image immediately previous to a return and an element image immediately subsequent to a return are not continuous.

Preferably, the paragraph information generating unit includes pieces of information including element images adjacent to each other in the scroll direction on the image file in same paragraph information.

Preferably, the element image extracting unit extracts, as the element image, an area obtained by extending the area where each of the element is present detected by the layout information detecting unit by a predetermined size.

The present invention provides a document file display method including the steps to be performed by an information processing apparatus, the steps including a step of converting a structured document file to an image file, a step of detecting layout information including an area where each of elements configuring a document is present and an alignment direction of the elements from the converted image file, a step of extracting, from the image file, an element image, which is a partial image corresponding to the area where each of the elements is present, based on the detected layout information, a step of generating line information with a set of the element images fitting in a display unit that displays an image, based on a size of each of the extracted element images along the alignment direction of the elements, a step of determining a scroll direction of the generated line direction according to the alignment direction of the elements, a step of generating paragraph information by arranging a plurality of pieces of said line information along the determined scroll direction, a step of making a display of the generated paragraph information in a display range of the display unit, a step of making an instruction for scroll display of the paragraph information along the scroll direction, and a step of making a scroll display of the paragraph information in the display range of the display unit along the instructed scroll direction.

The present invention provides a non-transitory computer-readable medium having a document file display program recorded thereon, the program for causing an information processing device to perform the document file display method.

According to the present invention, line information with a size fitting in the display unit is configured of element images arranged along an alignment of elements in an original image file, and paragraph information with the line information aligned in a scroll direction is generated. A user can read through a document while checking the contextual relation of the line information only by scrolling the paragraph information along the scroll direction, and is not required to read through the document while scrolling here and there in a plurality of directions.

### BRIEF DESCRIPTION OF THE DRAWINGS

FIG. 1 is a diagram of a schematic structure of a content distribution system.

FIG. 2 is a diagram depicting an example of an image file outputted from an image output unit.

FIG. 3 is a diagram depicting a line layout information table.

FIG. 4 is a diagram depicting a character layout information.

FIG. 5 is a diagram schematically depicting the state in which layout information is obtained at an OCR.

FIG. 6 is a flowchart of a document distributing process.

FIG. 7 is a diagram depicting an example of a preview display of an original image.

FIG. 8 is a diagram depicting an example of a selected document area.

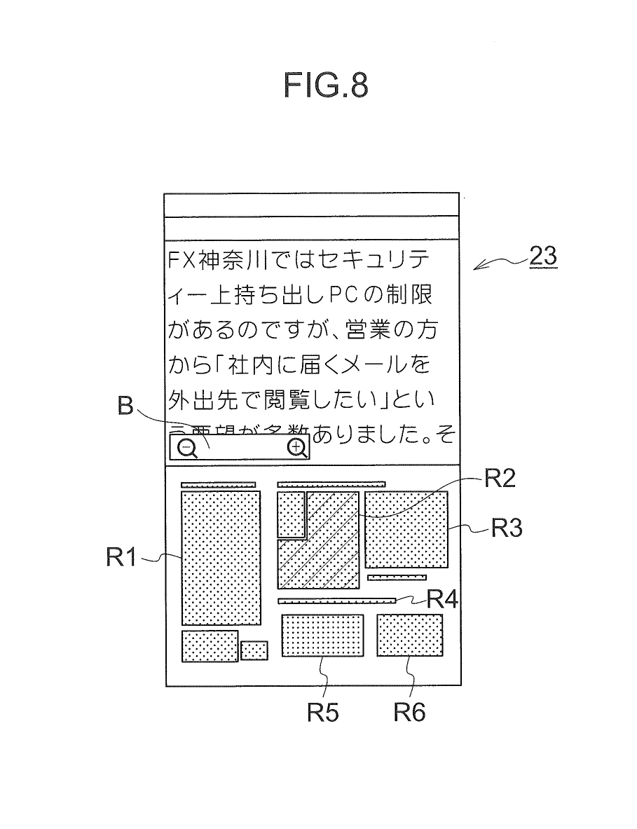

FIG. 9 is a detailed flowchart of document layout reconfiguration (A7).

FIG. 10 is a diagram depicting an example of a character recognition area where a missing part occurs in a peripheral part of a character.

FIG. 11 is a diagram depicting an example of the character recognition area where a missing part occurs in a lower part of characters.

FIG. 12 is a diagram depicting the state in which a range expanded by several pixels from height and width size values of OCR-recognized characters is extracted again as a recognized character image.

FIG. 13 is a diagram depicting line information generation.

FIG. 14 is a diagram depicting line information generation (separation).

FIG. 15 is a diagram depicting line information generation (unification).

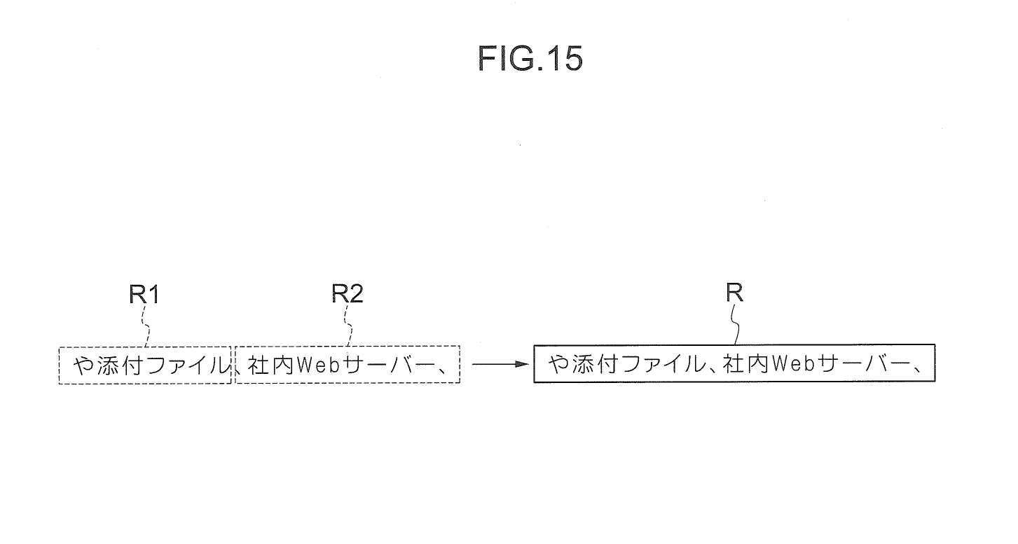

FIG. 16 is a diagram depicting an example of the original image.

FIG. 17 is a diagram depicting an example of reconfiguration of a display image for document viewing.

FIG. 18 is a diagram depicting an example of adjacent line information.

FIG. 19 is a diagram depicting the state in which two or more pieces of line information are coupled together while a shift at a head line is kept.

FIG. 20 is a diagram depicting an example of paragraph information generated to keep a return in the original image.

FIG. 21 is a diagram depicting conventional character arrangement by OCR.

### DETAILED DESCRIPTION OF THE PREFERRED EMBODIMENTS

### First Embodiment

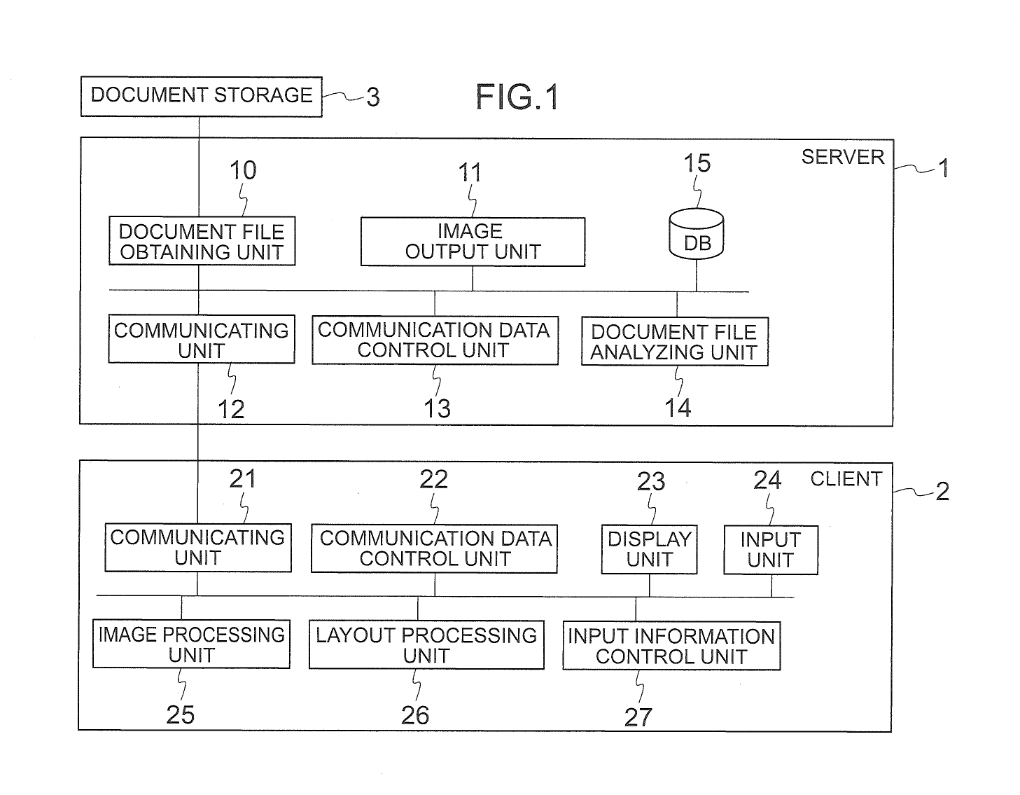

FIG. 1 depicts the structure of a content distribution system according to a preferable embodiment of the present embodiment. This system includes a server 1 and a client 2. The server 1 is configured of a computer (an information processing device) including a computing device (CPU), a storage device, an input/output circuit, etc. The client is an information terminal including display means capable of reproducing images, communicating means, a computing device (CPU), a storage device, an input/output circuit, operating means, etc., and is configured of, for example, a smartphone or a tablet-type computer. Note that an indefinite number of clients 2 may access the server 1.

Specifically, the server 1 includes a document file obtaining unit 10, an image output unit 11, a communicating unit 12, a communication data control unit 13, a document file analyzing unit 14, and a database (DB) 15.

The communication data control unit 13 and the document file analyzing unit 14 are each configured of an information processing device such as a CPU. The DB 15 is configured of a storage medium such as a hard disk or a memory. The document file obtaining unit 10, the image output unit 11, and the communicating unit 12 are each configured of an input/output device, a network communication device, etc. Communication-related control such as starting and ending transmission and reception of information is governed by the communication data control unit 13.

The communication data control unit 13 performs reception data control and transmission data control. The reception data control includes a process of analyzing data obtained by the communicating unit 12. The transmission data control includes a process of changing an image, layout information, and text information generated by the document file analyzing unit 14, and the image output unit 11 to a specific data format and transmitting the changed image and information to the communicating unit 12.

The document file obtaining unit 10 obtains a document file structured in any of various formats (such as doc, txt, pdf, ppt, and xls) from a document storage 3 connected via a network. Which document is to be obtained is specified by the client 2 or by a user by using operating means of the server 1.

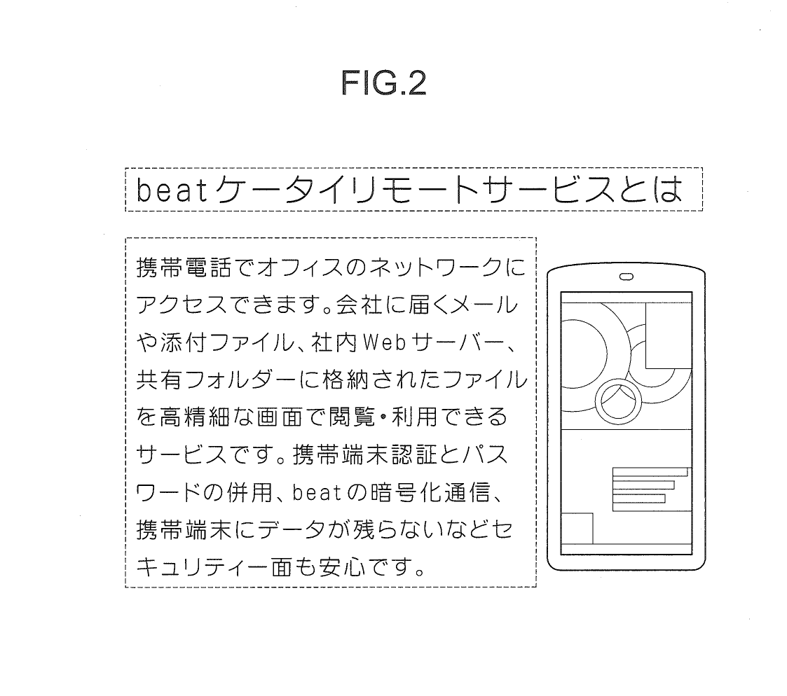

Upon request from each block of the client 2 and the server 1, the image output unit 11 converts the document file obtained by the document file obtaining unit 10 to an image file format (such as jpg, tif, or bmp) reproducible at the client 2, and outputs the converted document file to the document file analyzing unit 14. FIG. 2 depicts an example of an image file outputted from the image output unit 11. The image file outputted from the image output unit 11 may be hereinafter referred to as an original image. FIG. 2 contains texts in Japanese “WHAT IS beat PORTABLE PHONE REMOTE SERVICE IT ALLOWS PORTABLE PHONE ACCESS TO YOUR OFFICE NETWORK. THIS IS A SERVICE CAPABLE OF VIEWING AND USING E-MAILS AND FILES DELIVERED TO YOUR OFFICE AND FILES STORED IN YOUR INTRA-OFFICE WEB SERVER AND SHARE FOLDER WITH A HIGH-DEFINITION SCREEN. THE SERVICE ALSO REASSURES SECURITY, WITH COMBINED USE OF PORTABLE TERMINAL AUTHENTICATION AND A PASSWORD, beat ENCRYPTION COMMUNICATION, AND NO RESIDUAL DATA IN YOUR PORTABLE TERMINAL.”

The document file analyzing unit 14 discriminates an image area and a text area from the image file outputted from the image output unit 11, and analyzes, for each line, a layout of characters (including various symbols such as punctuations, question marks, and parentheses) on each line included in the text area. The layout of characters for each line is referred to as layout information. The layout information is accumulated in the DB 15 together with the image file.

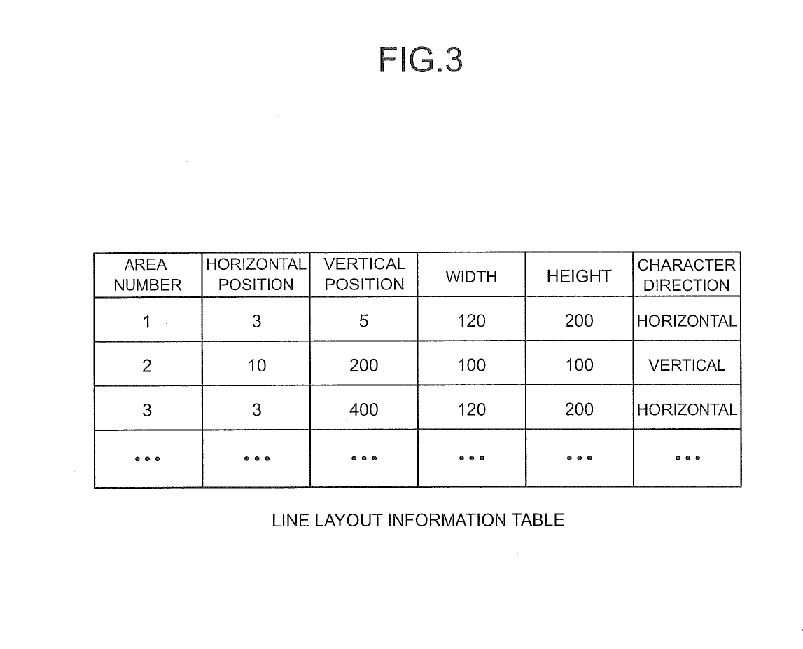

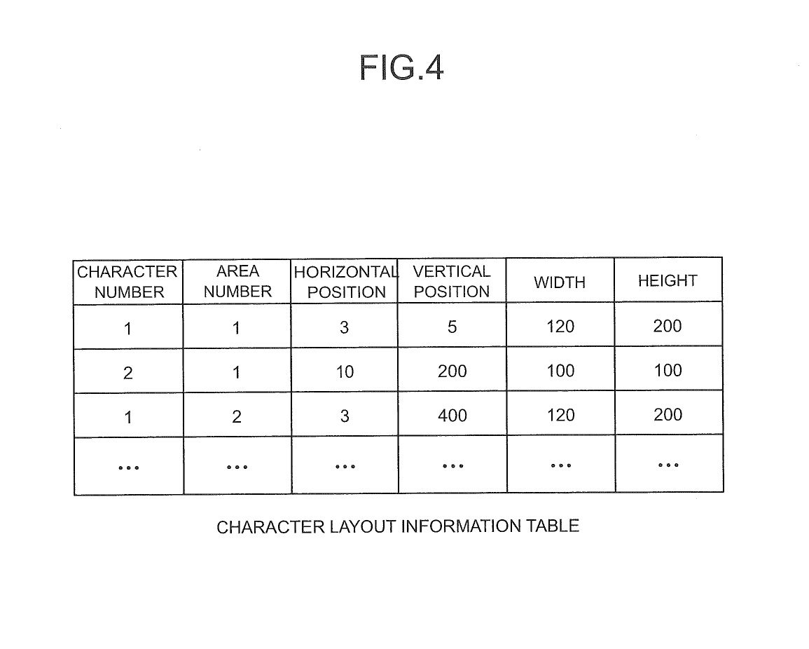

FIG. 3 and FIG. 4 each depict an example of layout information outputted from the document file analyzing unit 14. Of these figures, FIG. 3 depicts a line layout information table. The line layout information table has stored therein line layout information indicating identification information, a position (a vertical position and a horizontal position) and size (width and height), and line alignment direction (horizontal or vertical) of each line. The line refers to a character group with characters aligned along a reading direction of each character of an image file.

An area number indicates an ID provided to an area where each document is present in the original image. The horizontal position indicates upper-left coordinates of an area specified by the area number. The vertical position indicates lower-right coordinates of the area specified by the area number. The width indicates a width of the area specified by the area number (a length along the reading direction). The height indicates a height of the area specified by the area number (a length of the area in a direction orthogonal to the reading direction). A character direction indicates the reading direction of characters included in the area.

FIG. 4 depicts a character layout information table. The character layout information table has stored therein identification information (a character number) of each character included in each line, identification information (an area number) of the line where the character belongs, a position (a vertical position and a horizontal position), and a size (width and height).

The character number indicates an ID provided to each character. The area number, the horizontal position, the vertical position, the width, and the height are common to the line layout information table.

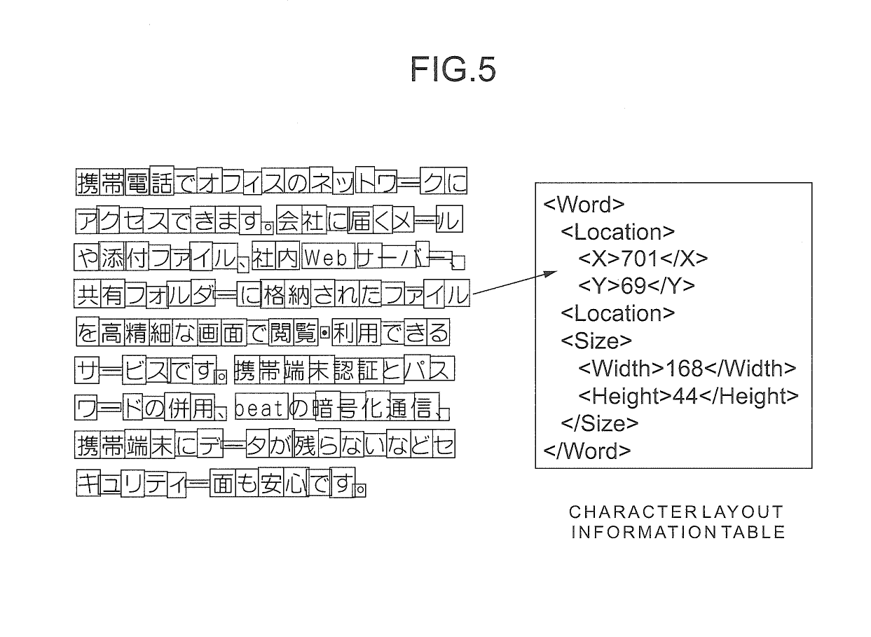

The layout information of a document file of a reproduction type by an application can be accurately obtained by using a character recognition logic such as an OCR (Optical Character Recognition) for an image generated by an application corresponding to the document file and incorporated in the image output unit 11. Alternatively, the image area and the text area in the document may be discriminated by a printer driver corresponding to the document file type and incorporated in the image output unit 11. The layout information may include a break position indicating a meaning unit such as a word or clause of the document and the number of characters in the meaning unit. However, characters themselves configuring the document are not included in the layout information. While the characters themselves may have an error, the position information can be sufficiently obtained by OCR with accuracy. FIG. 5 schematically depicts the state in which the layout information is obtained by OCR. The layout information is described by structured text information.

The layout information analyzed by the document file analyzing unit 14 is stored in the DB 15 in association with the original image outputted from the image output unit 11.

The communicating unit 12 transmits the original image and the layout information in the DB 15 to the client 2, under the control of the communication data control unit 13.

The client 2 includes a communicating unit 21, a communication data control unit 22, a display unit 23, an input unit 24, an image processing unit 25, a layout processing unit 26, and input information control unit 27.

The communication data control unit 22, the image processing unit 25, the layout processing unit 26, and the input information control unit 27 are each configured of an information processing device such as a CPU.

The communication data control unit 22 performs reception data control and transmission data control. The reception data control includes a process of analyzing classifying data obtained by the communicating unit 21. As a result of classification and analysis, the layout information is sent to the layout processing unit 26, and the original image is sent to the image processing unit 25. The transmission data control includes a process of changing various requests such as an instruction inputted from the user to a specific data format and transmitting the changed requests to the communicating unit 21.

The communicating unit 21 is configured of a network communication device or the like, is connected to the communicating unit 12 of the server 1 via a network such as the Internet, and transmits and receives various information. Communication-related control such as starting and ending transmission and reception of information is governed by the communication data control unit 22.

The input unit 24 is configured of a user interface such as a touch panel laminated on the display unit 23, and accepts various operations such as those for scrolling, enlarging, and reducing a displayed image, obtaining the subsequent or previous page, obtaining the original image with high definition, and selecting an area.

The input information control unit 27 interprets an instruction corresponding to the operation inputted to the input unit 24, and sends the instruction to a block involved in execution of the instruction, for example, the image processing unit 25, the layout processing unit 26, and the communication data control unit 22. This instruction includes instructions for scrolling, enlarging, and reducing a displayed image, obtaining the subsequent or previous page, obtaining the original image with high definition, and selecting an area. In response to any of these instructions, for example, the image processing unit 25 causes scrolling, enlarging, and reducing of a displayed image, colored highlight display of a selected area, obtainment of the subsequent or previous page, and obtainment of the original image with high definition.

The image processing unit 25 processes image data obtained from the communication data control 22 (enlargement, reduction, translation, and scroll) and performs a layout reconstructing process.

The layout processing unit 26 generates a display image to be sent to the display unit 23, based on the processed image data obtained from the image processing unit 25 and the layout information obtained from the communication data control unit 22.

The layout processing unit 26 determines an arrangement of the document included in the image file, based on the layout information transmitted from the server 1 and attributes of the display unit 23 (such as a screen height, a screen width, and resolution).

The display unit 23 is configured of an LCD monitor or the like, and is display-controlled by the image processing unit 25 in a centralized manner.

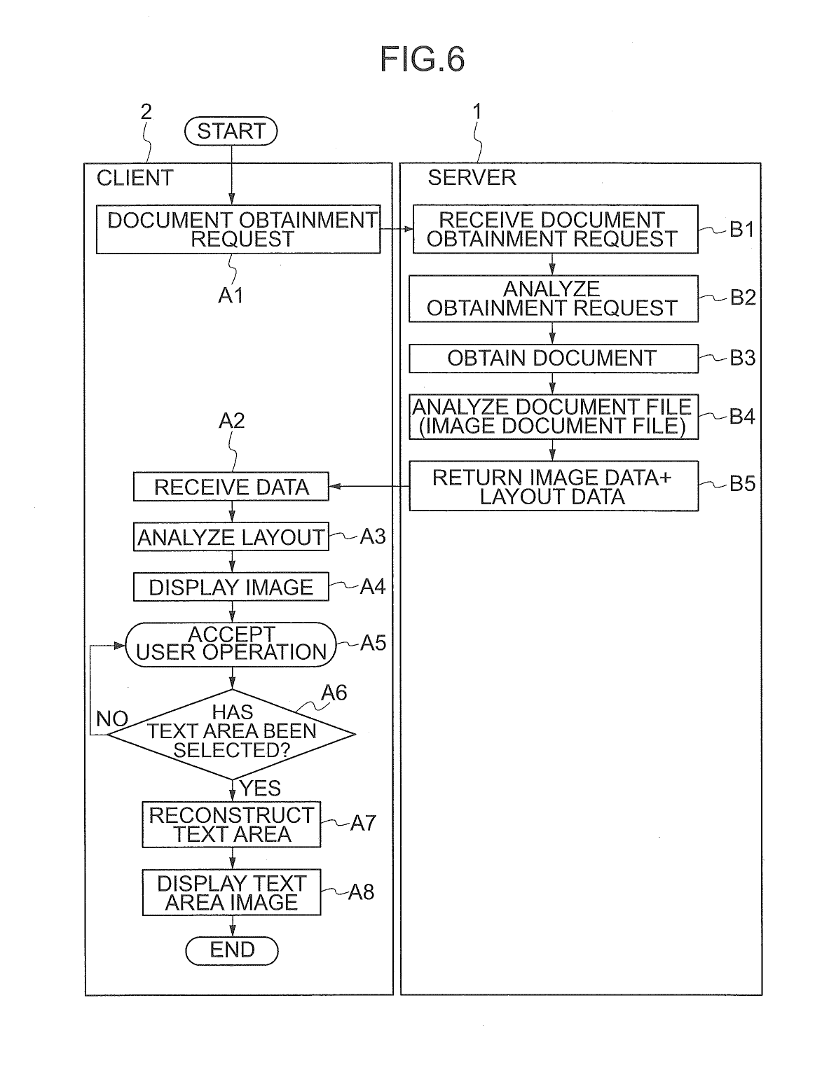

FIG. 6 is a flowchart of a document distributing process performed by the content distribution system. A program for performing this process is stored in the memories of the server 1 and the client 2, and is performed by each block of the server 1 and the client 2. In the following, the client 2 performs processes A1 to A8, and the server 1 performs processes B1 to B6.

At A1, the input information control unit 27 of the client 2 selects a desired document file from the documents accumulated in the document storage 3 based on an input to the input unit 24. The communication data control unit 22 requests, via the communicating unit 21, the server 1 to obtain the selected document file. For example, with the input unit 24 and the input information control unit 27 of the client 2 selecting a desired document file from URLs in a file name list provided from the document storage 3, a document obtainment request is generated. Alternatively, the client 2 can select a desired image file from the documents accumulated in the DB 15 and request the server 1 to obtain the selected image file.

At B1, upon receiving the document obtainment request from the client 2 via the communicating unit 12, the communication data control unit 13 of the server 1 proceeds to B2.

At B2, the communication data control unit 13 of the server 1 analyzes and classifies the received document obtainment request, and obtains identification information of the client 2 as a request source (such as a network address) and identification information of the requested document file (such as a file name).

At B3, the document file obtaining unit 10 of the server 1 obtains an image file corresponding to the requested document file from the DB 15. If the document file is not present in the DB 15, the document file obtaining unit 10 of the serve 1 obtains the requested document file from the document storage 3, and the document file is converted to an image file at the image output unit 11.

At B4, the document file analyzing unit 14 of the server 1 analyzes the document file obtained from the document storage 3 to obtain layout information. The document file analyzing unit 14 of the server 1 stores the obtained layout information in the DB 15 in association with the requested image file.

At B5, the communication data control unit 13 of the server 1 transmits the image file of the requested document file and the layout information corresponding thereto to the client 2 via the communicating unit 12.

At A2, the communication data control unit 22 of the client 2 receives the image file and the layout information transmitted from the server 1 via the communicating unit 21.

At A3, the layout processing unit 26 of the client 2 analyzes an attribute (size) of the display unit 23, a document enlargement/reduction ratio, and a document line direction. Among these pieces of information, the attribute (size) of the display unit 23 may be stored in advance in a ROM or the like of the client 2.

At A4, the client 2 performs a preview display of the entire image of the image file.

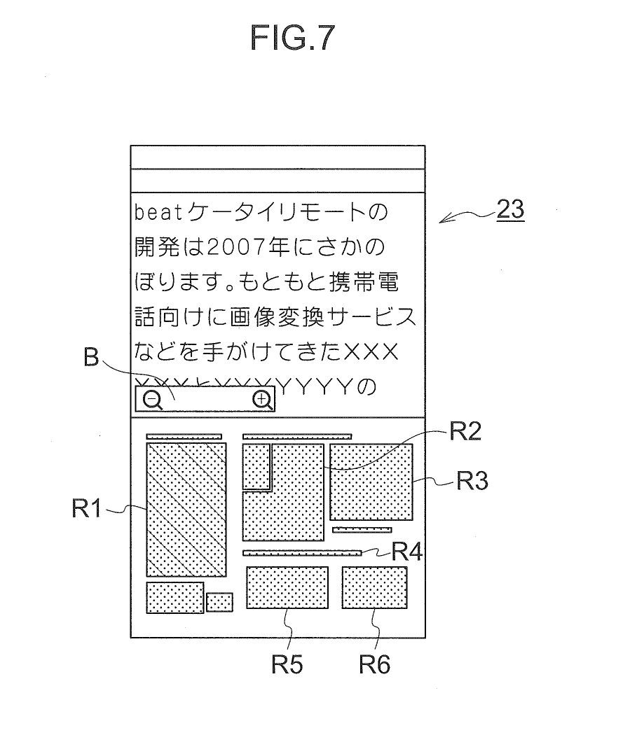

At A5, the client 2 accepts, via the input unit 24, a selection of a document area to be display from the entire original image on preview display. For example, the original image including document areas R1 to R6 is on preview display in FIG. 7, and the area R2 is selected as a document area to be displayed. The selected document area is visually distinguished by coloring or the like.

At A6, the input information control unit 27 of the client 2 determines whether document area to be displayed has been selected. If Yes, the procedure proceeds to A7. If No, waiting for this selection continues.

At A7, the image processing unit 25 of the client 2 determines an optimum layout of the selected document area based on the attribute (size) of the display unit 23, the document enlargement/reduction ratio, and the document line direction, reconfiguring the layout of the document included in the selected document area. Details of this process will be described further below.

At A8, the image processing unit 25 of the client 2 causes the document included in the selected document area to be displayed on the display unit 23 with the reconfigured optimum layout. A preview display area of the image and the display area of the document in the selected document area are different.

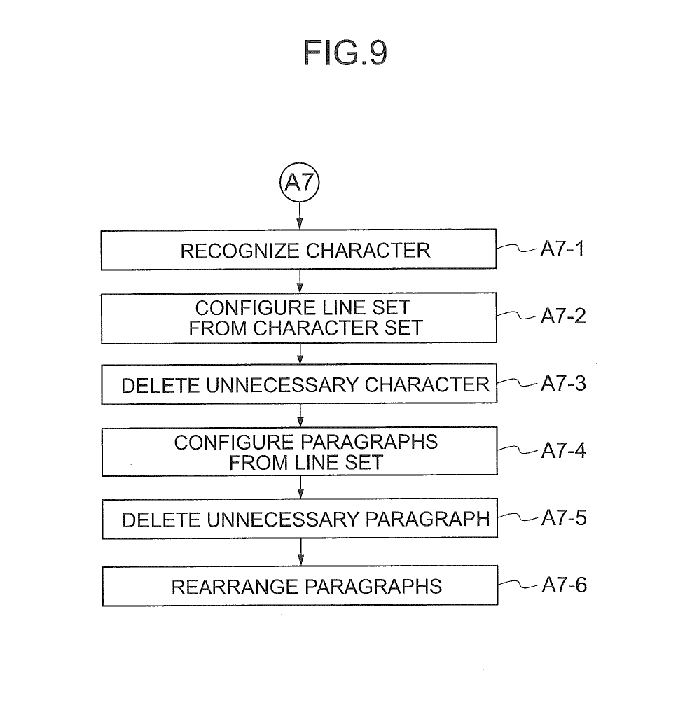

FIG. 9 depicts details of document layout reconfiguration (A7). This process is performed by the image processing unit 25 and the layout processing unit 26.

At A7-1, the layout processing unit 26 obtains layout information of each character of the original image. This may be layout information obtained as a result of analysis by the document file analyzing unit 14 of the server 1 or may be layout information obtained as a result of similar analysis performed by the layout processing unit 26 of the client 2.

The layout processing unit 26 extracts a character image rendered in a character recognition range (a partial image corresponding to a range where a character is present) based on the layout information.

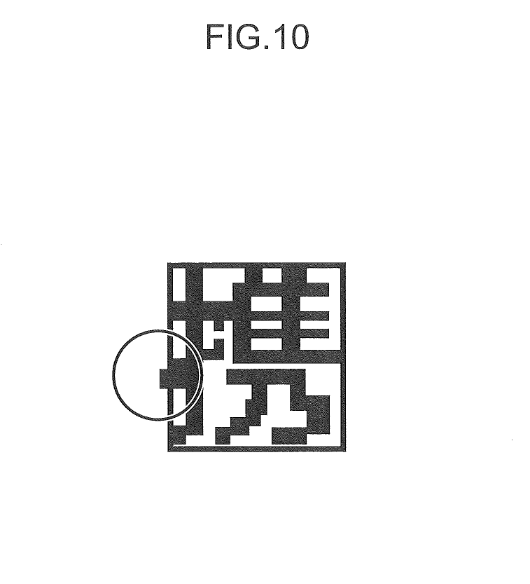

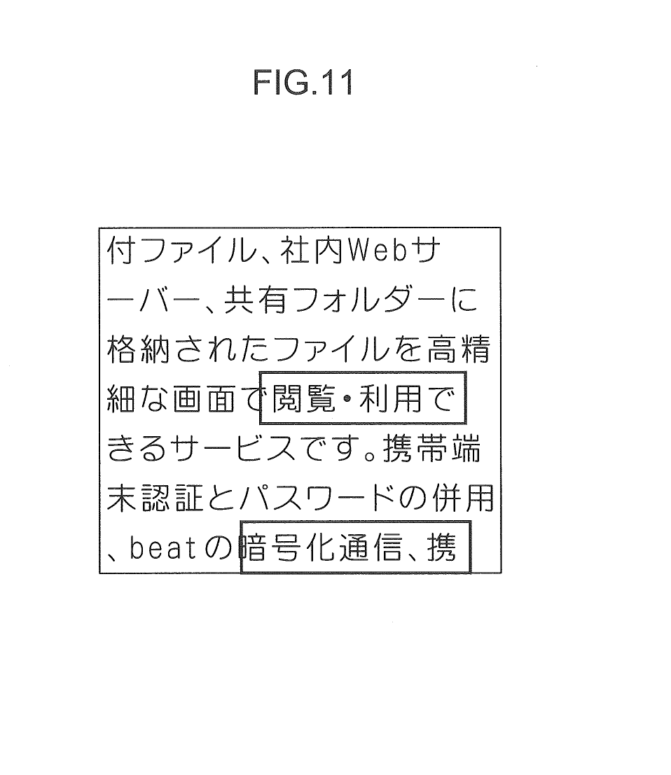

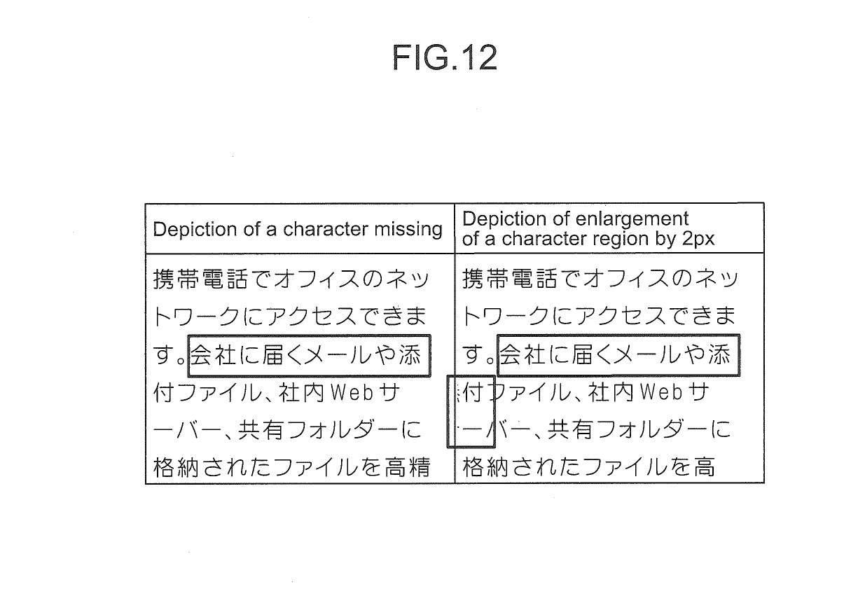

As exemplarily depicted in FIG. 10, in character recognition by OCR, a character image rendered in the character recognition range (a partial image corresponding to a range where a character is present) may have a shift, and a missing part may occur in a peripheral part of the character. In particular, as exemplarily depicted in FIG. 11, it is known that a character missing part often occurs in a lower part of characters. For this reason, as exemplarily depicted in FIG. 12, a range expanded by several pixels from height and width values of the OCR-recognized characters is extracted again as a recognized character image. Here, note that not the characters themselves but the range where the characters are present on the original image is recognized. Note that a character image is not extracted from a character recognition range not satisfying a predetermined size or, if extracted, such a character image is deleted.

At A7-2, the layout processing unit 26 generates one or plurality of pieces of line information from a set of the recognized character images. The direction in which the lines are arranged follows the character direction of the layout information.

The character direction herein is different from a scroll direction of a display image. In consideration of operability, the scroll direction is preferably a direction orthogonal to the line direction. In further consideration of operability, the number of scroll directions is preferably one. If a plurality of scroll directions such as horizontal and vertical directions are present as in the conventional technologies, the document is viewed by scrolling here and there. This is not user-friendly.

The number of character images, n, for generating line information for one line on the display unit 23 depends on a size aᵢ of each character image, a size b of the display unit 23 in the line direction, and a character enlargement/reduction ratio c. That is, when each character is enlarged or reduced at a desired enlargement/reduction ratio and each character after enlargement/reduction is aligned in the line direction with the alignment identical to that of the selected document of the original image being kept in a maximum range not exceeding the size of the display unit 23 in the character direction, a set of these characters is a line set for each line. The size of a character set for one line is represented by a maximum value Lmax of L satisfying

L=Σaᵢ*c*n≦b (1).

Here, Σaᵢ is a total sum (line information) of adjacent character images. Therefore,

n=Lmax/(Σaᵢ*c) (2).

Since b is a fixed value, as the character enlargement/reduction ratio c increases, the number of characters, n, per line on the display unit 23 decreases accordingly. Any enlargement/reduction ratio c is specified, for example, by the user via an enlargement/reduction button B of FIG. 7.

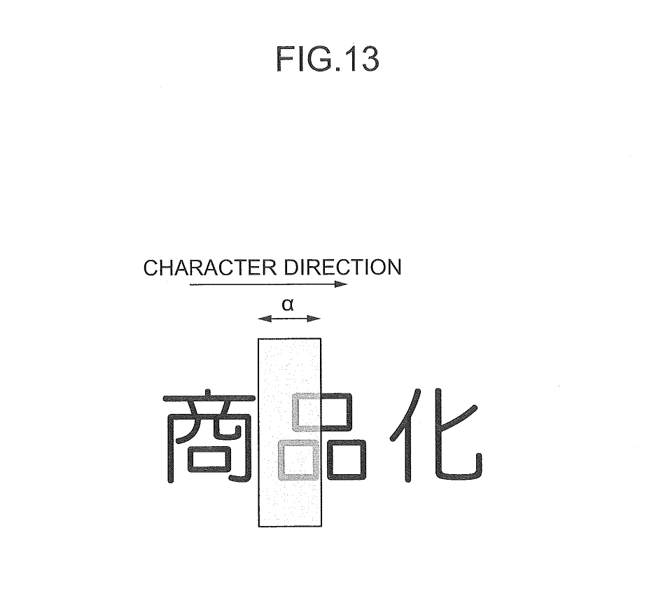

The line information Σaᵢ is determined as follows. For example, it is assumed as in FIG. 13 that an area with a predetermined size α adjacent to a character image of a Chinese character “sho”, which is the previous character image, for example, an area with a breadth of 30% of the breadth of the character image of “sho”, partially overlaps an area where a character image of a Chinese character “hin” is present. In this case, the layout processing unit 26 determines that the character image adjacent to the character image of “sho” is the character image of “hin” and these are included in the same line information.

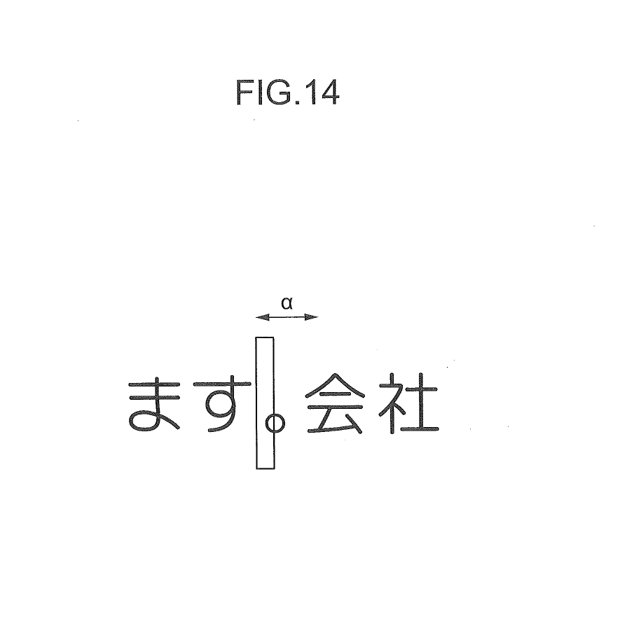

Conversely, it is determined that the previous character image not satisfying the predetermined size and a character image adjacent thereto are regarded as not being adjacent to each other. For example, a character image of a period symbol in Japanese as depicted in FIG. 14 is regarded as being below the predetermined size α and not being adjacent to the next character image of a Chinese character “kai”. That is, the character images of the period symbol and “kai” are separated as another line information.

However, even when it is determined that character images are not adjacent to each other, if the character images have coordinates common to each other on the original image and the size obtained by coupling the character images together fits in the display range of the display unit 23, these are unified to the same line information. For example, two line sets R1 and R2 are decoupled at a character image of a comma in Japanese not satisfying the predetermined size α, but the size obtained by unifying these character images fits in the display range of the display unit 23, and therefore these are taken as new line information R.

The layout processing unit 26 sets a cutout frame including n character images as an original image, and cuts out a chunk of character images for one line. Then, the cutout chunk of character images is arranged for one line along the scroll direction.

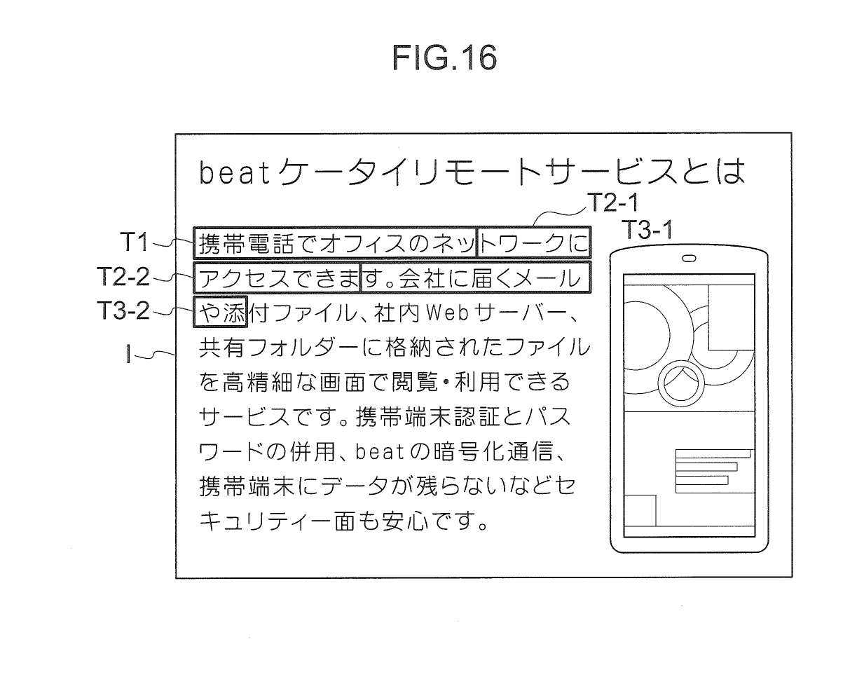

For example, it is assumed that an original image I as in FIG. 16 is present and the number of characters per line of the display unit 23 is calculated as n=12. In this case, as a cutout frame for the first line, a frame T1 including twelve character images on the first line of the original image I is set to the image I as a cutout frame for the first line. Next, a frame T2 formed of a frame T2-1 including five character images on the first line of the original image I and a frame T2-2 including seven character images on the second line of the original image I is set to the image I as a cutout frame for the second line. Next, a frame T3 formed of a frame T3-1 including ten character images on the second line of the original image I and a frame T3-2 including two character images on the third line of the original image I is set to the image I as a cutout frame for the third line. Thereafter, similarly, a frame Tk on a k+1-th line is set so as to include a character image not included in a frame for the previous k-th line to a character image after n character images.

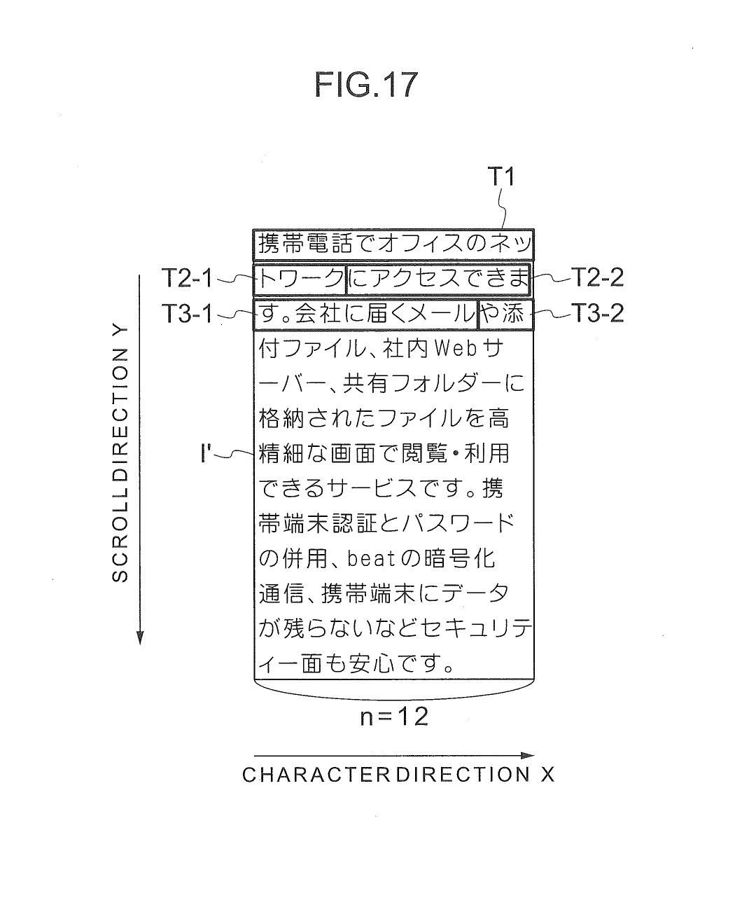

As exemplarily depicted in FIG. 17, the layout processing unit 26 arranges a partial image included in the frame Tk on a k-th line along the scroll direction. By repeating the line arrangement in this manner, a display image P for document viewing at the client 2 is reconfigured from the original image I. The size in a character direction X in which the display image I′ is not scrolled is equal to or smaller than the size of the display unit 23. That is, regarding the character direction X, even if the size of the image I′ and the size of the display unit 23 are different from each other, it is assumed that only a subtle difference to the extent of not requiring a scroll in the character direction is present.

At A7-3, the layout processing unit 26 deletes an unnecessary character line from among the line set. The unnecessary character line refers to line information for only one character. The reason for this is that there is a high possibility that the line information for only one character is obtained due to erroneous recognition of a part of a character as a character. However, the unnecessary character line is not restricted to the line information for only one character.

At A7-4, the layout processing unit 26 determines a scroll direction based on the character direction. Normally, to allow a viewing person to easily select a line to be read, the character direction and the scroll direction are assumed to have a orthogonal relation. For example, the layout processing unit 26 determines a scroll direction from the character direction in a manner such that the scroll direction is vertical if the character direction is horizontal and the scroll direction is horizontal if the character direction is vertical.

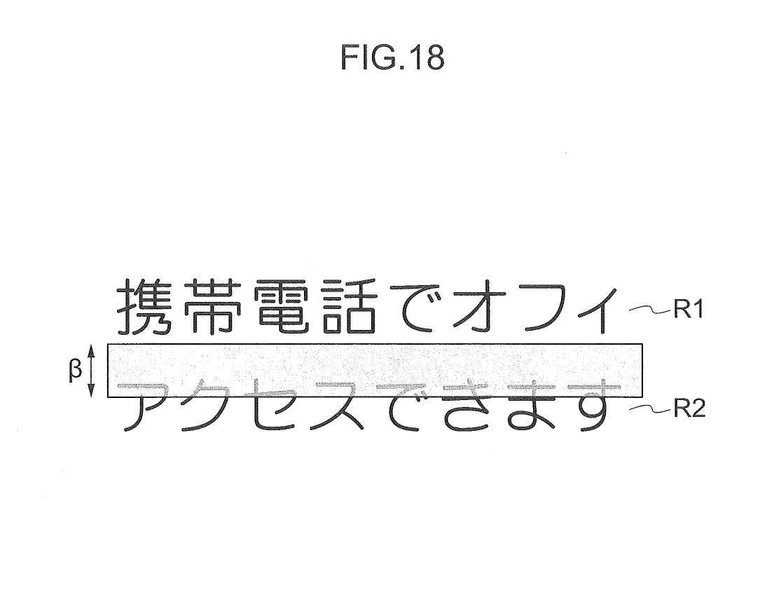

The layout processing unit 26 couples pieces of line information adjacent to each other along the determined scroll direction to generate paragraph information. For example, as in FIG. 18, with reference to the original image and the character direction thereof, line information R2 (subsequent line information R2) including character images present in a predetermined range P from a lower end of line information including character images on an upstream side (previous line information R1), for example, in a range of 50% of the height of the character images on the previous line information R1, is determined as line information adjacent to R1. The layout processing unit 26 couples the adjacent line information R1 and R2 and sets the coupled line information as the same paragraph information. The layout processing unit 26 repeats this determination regarding adjacent pieces of line information and coupling for each line information, thereby generating paragraph information.

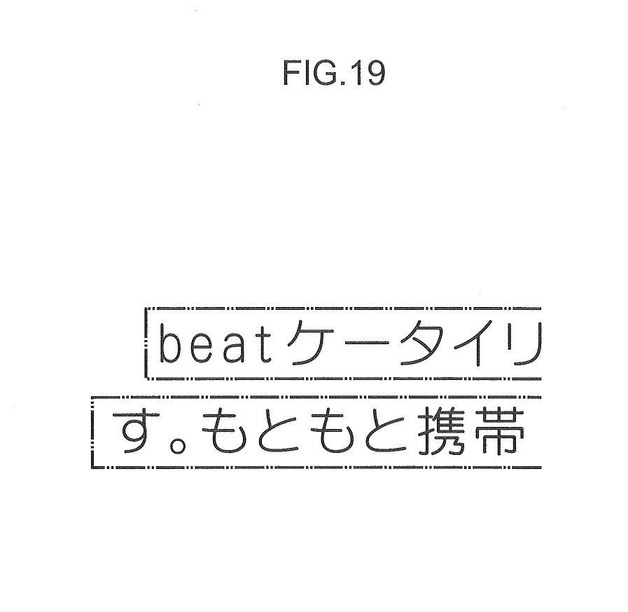

Note that, as exemplarily depicted in FIG. 19, the layout processing unit 26 may couple two or more pieces of line information while keeping a shift at a line head.

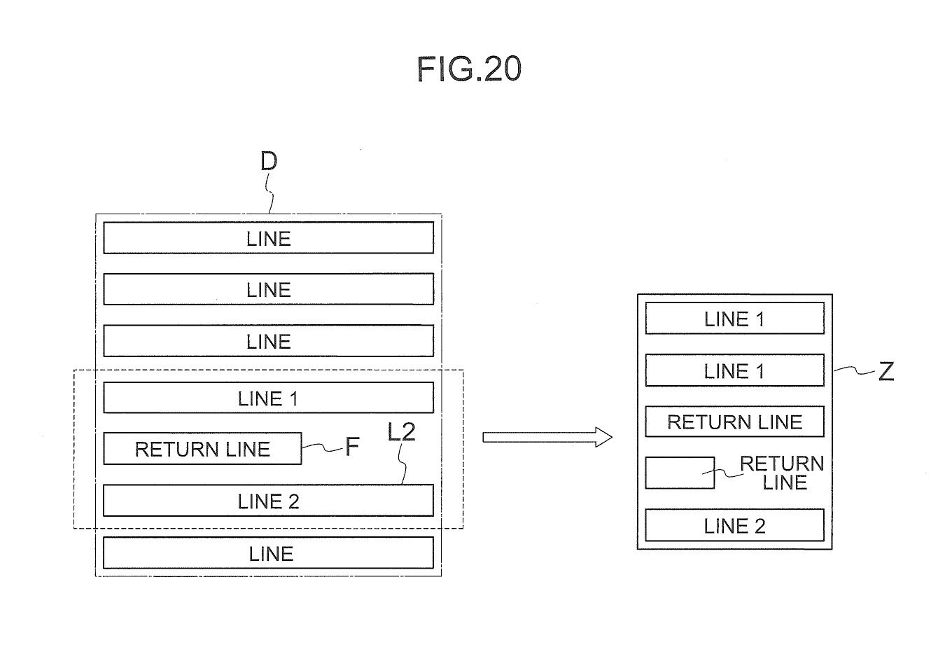

Alternatively, the layout processing unit 26 may generate line information so as to keep a return in the document area of the original image. That is, as exemplarily depicted in FIG. 20, when a line F with a return in the middle is identified in lines in a selected document area D of the original image, the layout processing unit 26 does not couple, to a character image on the tail of this line F, the first character image on the immediately subsequent line L2, and generates line information and paragraph information Z so that these character images are not continuous on the same line information.

At A7-5, the layout processing unit 26 determines and deletes an unnecessary paragraph from the paragraph information. The unnecessary paragraph is determined according to the paragraph area and the number of characters in the paragraph. For example, if a total sum of character areas included in a paragraph is equal to or smaller than a ratio with respect to the area of the original image (such as 0.1%), that paragraph is determined as an unnecessary paragraph. Alternatively, if the number of characters included in a paragraph is equal to or smaller than a predetermined number (such as two), that paragraph is determined as an unnecessary paragraph. That is, a paragraph with an extremely small number of characters is deleted as not suitable for viewing.

At A7-6, the layout processing unit 26 aligns and couples paragraphs after deleting an unnecessary paragraph along the scroll direction to reconfigure paragraph information, and takes this as a new display image I′. Then, the procedure proceeds to A8, thereby displaying the display image I′.

The size of the display image I′ in the character direction is identical to the size of the display unit 23, and no scroll is required. However, the size of the display image I′ in the scroll direction may exceed the size of the display unit 23. Therefore, the display range of the display image I′ in the scroll direction is restricted to the size of the display unit 23, resulting in a partial display.

Thus, the input information control unit 27 accepts an instruction regarding the scroll direction defined by the character direction, and sends the instruction to the image processing unit 25. The image processing unit 25 causes the display image I′ to be scrolled as the scroll instruction, and causes a range advanced by scroll to be displayed. However, the input information control unit 27 may not accept and may ignore any other instruction regarding the scroll direction.

When the input information control unit 27 accepts a change of the enlargement/reduction ratio of the display image I′, the procedure returns to A7-1, thereby reconfiguring the display image I′ optimum for the changed enlargement/reduction ratio.

According to the processes described above, line information of the same size as the horizontal screen size is generated with character images along the alignment of the characters of the original image. Furthermore, from paragraph information with that line information aligned in the scroll direction, the display image I′ is generated. The user can read through the document while checking the contextual line relation only by scrolling the display image I′ along the scroll direction orthogonal to the character direction, and is not required to read through the document while scrolling here and there in a plurality of directions.

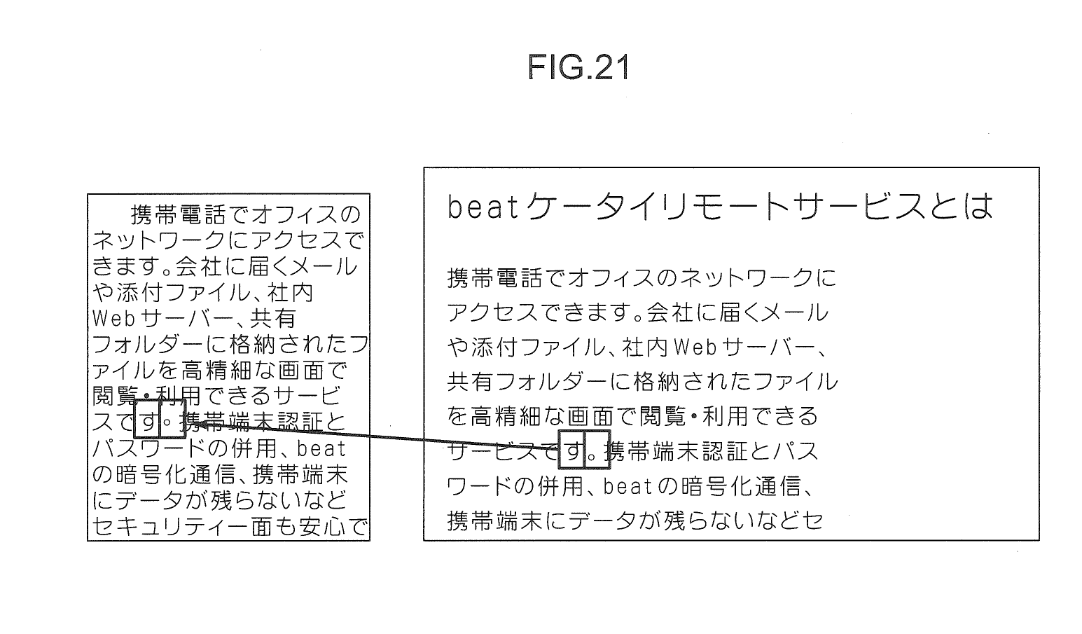

Conventionally, when characters themselves are recognized by OCR and the recognized characters are aligned to generate line, the following problems occur. (1) it is difficult to reproduce a subtle balance between characters, and (2) it is difficult to correctly arrange punctuations (refer to FIG. 21). However, these problems do not occur in the present processes, because the images themselves are aligned to reconfigure images for viewing.

Also, images for viewing are reconfigured according to any specified enlargement/reduction ratio. Therefore, it is possible to read through the document while checking the contextual line relation, even with any enlargement/reduction ratio.

Furthermore, in the above description, the language of the document is Japanese, and characters configuring a document are hiragana, katakana, and Chinese characters. However, the application range of the present invention is not restricted thereto. For example, the application range of the present invention can include various characters such as Chinese, hangul characters, alphabets, Cyrillic characters, and Arabic characters for use in various languages such as Chinese, Korean, English, German, French, Spanish, Russian, and Arabic.

What is claimed is:

1. A document file display device comprising:
a display unit that displays an image;
an image converting unit that converts a structured document file to an image file;
a layout information detecting unit that detects layout information including an area where each of elements configuring a document is present, the sizes of each of the elements, and an alignment direction of the elements from the converted image file by the image converting unit;
an element image extracting unit that extracts, from the image file, an element image, which is a partial image corresponding to the area where each of the elements is present, based on the layout information detected by the layout information detecting unit;
a line information generating unit that generates line information with a set of the element images fitting in the display unit, based on the summation of the sizes of each of the element images extracted by the element image extracting unit along the alignment direction of the elements;
a scroll direction determining unit that determines a scroll direction of the line information generated by the line information generating unit according to the alignment direction of the elements;
a paragraph information generating unit that generates paragraph information by arranging a plurality of pieces of said line information along the scroll direction determined by the scroll direction determining unit;
a display control unit that that makes a display of the paragraph information generated by the paragraph information generating unit in a display range of the display unit; and
a scroll instructing unit that makes an instruction for scroll display of the paragraph information along the scroll direction,
wherein the display control unit makes a scroll display of the paragraph information in the display range of the display unit along the scroll direction instructed by the scroll instructing unit.

2. The document file display device according to claim 1, wherein
the display control unit makes a reduced display of the image file as a whole and also causes information indicating an area where each document in the reduced and displayed image is present to be displayed, and
the document file display device further comprises an area selecting unit that selects an area where a desired document is present from the area where each document is present,
the layout information detecting unit detects the layout information including the area where each of the elements is present and the alignment direction of the elements from the area where the document is present selected by the area selecting unit, and
the display control unit makes a scroll display of paragraph information corresponding to the area where the document is present selected by the area selecting unit along the scroll direction instructed by the scroll instructing unit in a first area of the display unit in the display range of the display unit, and makes a reduced display of the whole image file in a second area different from the first area of the display unit.

3. The document file display device according to claim 1, wherein
the scroll direction determining unit determines a direction orthogonal to the alignment direction of the elements as the scroll direction of the line information.

4. The document file display device according to claim 1, further comprising an enlargement/reduction ratio specifying unit that specifies an enlargement/reduction ratio for displaying the paragraph information, wherein
the line information generating unit generates the line information with the set of the element images fitting in the display unit along the alignment direction of the elements, by following on a size obtained by enlarging or reducing each of the element images extracted by the element image extracting unit at the enlargement/reduction ratio specified by the enlargement/reduction ratio specifying unit.

5. The document file display device according to claim 1, wherein
the line information generating unit deletes, from the line information, an element image not satisfying a predetermined criterion.

6. The document file display device according to claim 1, wherein
the paragraph information generating unit deletes, from the paragraph information, line information not satisfying a predetermined criterion.

7. The document file display device according to claim 1, wherein
the line information generating unit includes element images adjacent to each other in the alignment direction of the elements on the image file in same line information.

8. The document file display device according to claim 7, wherein
the line information generating unit includes an element image subsequent to an element image adjacent to a previous element image previous to element images not satisfying a size at a predetermined ratio along the alignment direction of the elements in line information different from line information of the previous element image.

9. The document file display device according to claim 8, wherein
when a size obtained by coupling different pieces of line information fits in the display unit along the alignment direction of the elements, the line information generating unit unifies the different line information into same line information.

10. The document file display device according to claim 7, wherein
the line information generating unit generates the line information so that an element image immediately previous to a return and an element image immediately subsequent to a return are not continuous.

11. The document file display device according to claim 1, wherein
the paragraph information generating unit includes pieces of information including element images adjacent to each other in the scroll direction on the image file in same paragraph information.

12. The document file display device according to claim 1, wherein
the element image extracting unit extracts, as the element image, an area obtained by extending the area where each of the element is present detected by the layout information detecting unit by a predetermined size.

13. A document file display method performed by an information processing apparatus, comprising:
a step of converting a structured document file to an image file;
a step of detecting layout information including an area where each of elements configuring a document is present, the sizes of each of the elements, and an alignment direction of the elements from the converted image file;
a step of extracting, from the image file, an element image, which is a partial image corresponding to the area where each of the elements is present, based on the detected layout information;
a step of generating line information with a set of the element images fitting in a display unit that displays an image, based on the summation of the sizes of each of the extracted element images along the alignment direction of the elements;
a step of determining a scroll direction of the generated line direction according to the alignment direction of the elements;
a step of generating paragraph information by arranging a plurality of pieces of said line information along the determined scroll direction;
a step of making a display of the generated paragraph information in a display range of the display unit;
a step of making an instruction for scroll display of the paragraph information along the scroll direction; and
a step of making a scroll display of the paragraph information in the display range of the display unit along the instructed scroll direction.

14. A non-transitory computer-readable medium having a document file display program recorded thereon, the program causing an information processing device to perform the document file display method according to claim 13.

15. The document file display device according to claim 1, wherein the layout information includes the rate of enlargement/reduction of a character.

16. The document file display device according to claim 15, wherein the rate can be arbitrarily designated by a user.
